(19) United States
(12) Patent Application Publication
(10) Pub. No.: US 2025/0111234 A1
(43) Pub. Date: Apr. 3, 2025

(54) METHOD AND DEVICE FOR TRAINING A NEURAL NETWORK MODEL UTILIZING ZERO BUBBLE PIPELINE PARALLELISM

(71) Applicant: Garena Online Private Limited, Singapore (SG)

(72) Inventors: Penghui QI, Singapore (SG); Xinyi WAN, Singapore (SG); Guangxing HUANG, Singapore (SG); Min LIN, Singapore (SG)

(21) Appl. No.: 18/898,628

(22) Filed: Sep. 26, 2024

(30) Foreign Application Priority Data
Sep. 28, 2023 (SG) 10202302770R
Sep. 25, 2024 (SG) 10202402982V

(51) Int. Cl. G06N 3/084; G06N 3/0499

(52) U.S. Cl. CPC G06N 3/084; G06N 3/0499

(57) ABSTRACT

Various embodiments concern a computer-implemented method for training a neural network model utilizing zero bubble pipeline parallelism, the computer-implemented method including: performing a plurality of forward passes through the neural network model, wherein each forward pass of the plurality of forward passes transforms a corresponding input x to a corresponding output y; performing a plurality of backward passes through the neural network model, wherein the plurality backward passes are split into a plurality of gradient computation passes B and a plurality of parameters computation passes W; performing a plurality of gradient computation passes B for the corresponding input x and the corresponding output y; and determining pipeline bubbles and performing the plurality of parameters computation passes W during the pipeline bubbles.

### CROSS REFERENCE TO RELATED APPLICATIONS

This patent application claims the benefit and priority of Singaporean Provisional Patent Application No. 10202302770R, filed with the Intellectual property Office of Singapore on Sep. 28, 2023 entitled “ZERO BUBBLE PIPELINE PARALLELISM,” and of Singaporean Patent Application No. 10202402982V, filed with the Intellectual property Office of Singapore on Sep. 25, 2024, entitled “METHOD AND DEVICE FOR TRAINING A NEURAL NETWORK MODEL UTILIZING ZERO BUBBLE PIPELINE PARALLELISM,” the contents of which are incorporated by reference in their entireties.

### TECHNICAL FIELD

Various aspects of this disclosure relate to computer-implemented methods and devices for training a neural network model utilizing zero bubble pipeline parallelism.

### BACKGROUND

The realm of distributed model training has become a focal point in the deep learning community, especially with the advent of increasingly large and intricate models. Training these models often requires a vast amount of graphic processing units (GPUs) interconnected with various topologies. Various parallelism techniques have been proposed for training deep neural networks (DNN) in the past years. Data parallelism (DP) is the default strategy for models of small to moderate sizes due to its simplicity. However, beyond a model size, it is not possible to fit the model parameters in one single GPU, this is why model parallelism is used.

There are two main model parallel schemes, tensor parallelism (TP) and pipeline parallelism (PP). TP splits the matrix multiplication in one layer to several devices, while PP segments the entire model into different stages which can be processed across different devices. There is also another alternative to model parallelism, Zero Redundancy Optimizer (ZeRO) which shards parameters across devices, while keeping the simplicity of DP.

Recent research indicates that achieving optimal performance in large-scale training scenarios requires a non-trivial interaction of DP, TP and PP strategies. In the abundance of interconnection resources, e.g. NVLink between GPUs within one compute node, a hybrid of DP, TP and ZERO strategies works efficiently.

Pipeline parallelism is one of the key components for large-scale distributed training, yet its efficiency suffers from pipeline bubbles. Going deeper into the intricacies of pipeline parallelism, the efficiency of its implementation relies heavily on the amount of device idle time referred to as pipeline bubbles Due to the dependency between layers, bubbles seem inevitable. A previous method attempts to reduce the bubble ratio by increasing the number of concurrent batches in the pipeline. However, a direct consequence of this is an increase in peak memory demands. To mitigate this, GPipe discards part of the intermediate activations while recomputing them during the backward pass. Yet, this approach introduced a computation overhead of around 20%. A notable improvement to the limitation of GPipe is called the one-forward-one-backward (1F1B) scheduling.

1F1B offers faster memory clearance by early scheduling the backward passes. With the same number of microbatches, it yields similar bubble ratios but with a distinct advantage in peak memory. By assigning multiple stages to the same device, it further reduces the bubble size without the need for additional batches at the cost of more communication.

Despite various efforts, to this date the remaining bubbles still pose the largest issue for pipeline parallelism. Accordingly, efficient approaches for pipeline parallelism are desirable.

### SUMMARY

Various embodiments concern a computer-implemented method for training a neural network model utilizing zero bubble pipeline parallelism, the computer-implemented method including: performing a plurality of forward passes through the neural network model, wherein each forward pass of the plurality of forward passes transforms a corresponding input x to a corresponding output y; performing a plurality of backward passes through the neural network model, wherein the plurality backward passes are split into a plurality of gradient computation passes B and a plurality of parameters computation passes W; performing a plurality of gradient computation passes B for the corresponding input x and the corresponding output y; and determining pipeline bubbles and performing the plurality of parameters computation passes W during the pipeline bubbles.

According to one embodiment, each gradient computation pass B of the plurality of gradient computation passes B is performed after each forward pass of the plurality of forward passes for the corresponding input x and the corresponding output y.

According to one embodiment, each parameters computation pass W of the plurality of parameters computation passes W is performed after each gradient computation pass B of the plurality of gradient computation passes B for the corresponding input x and the corresponding output y.

According to one embodiment, the pipeline bubbles are idle times when the plurality of forward passes and the plurality of gradient computation passes B are not performed.

According to one embodiment, a heuristic algorithm is used to determine an optimal schedule for performing each step of the plurality of forward passes, the plurality of the gradient computation passes B and the plurality of parameters computation passes W.

According to one embodiment, activation memory of each step of the plurality of forward passes, the plurality of the gradient computation passes B and the plurality of parameters computation passes W is calculated.

According to one embodiment, the heuristic algorithm uses the calculated activation memory of each step of the plurality of forward passes, the plurality of the gradient computation passes B and the plurality of parameters computation passes W to determine the optimal schedule.

According to one embodiment, the calculated activation memory is used to schedule as many forward passes as possible before the gradient computation pass B to minimize the pipeline bubbles.

According to one embodiment, the neural network model is a feedforward neural network.

Various embodiments concern a system for training a neural network model utilizing zero bubble pipeline parallelism comprising: a processor, a memory, the memory storing at least one program code, the at least one program code loaded and executed by the processor to: performing a plurality of forward passes through the neural network model, wherein each forward pass of the plurality of forward passes transforms a corresponding input x to a corresponding output y; performing a plurality of backward passes through the neural network model, wherein the plurality backward passes are split into a plurality of gradient computation passes B and a plurality of parameters computation passes W; performing a plurality of gradient computation passes B for the corresponding input x and the corresponding output y; and determining pipeline bubbles and performing the plurality of parameters computation passes W during the pipeline bubbles.

According to one embodiment, each gradient computation pass B of the plurality of gradient computation passes B is performed after each forward pass of the plurality of forward passes for the corresponding input x and the corresponding output y.

According to one embodiment, each parameters computation pass W of the plurality of parameters computation passes W is performed after each gradient computation pass B of the plurality of gradient computation passes B for the corresponding input x and the corresponding output y.

According to one embodiment, the pipeline bubbles are idle times when the plurality of forward passes and the plurality of gradient computation passes B are not performed.

According to one embodiment, a heuristic algorithm is used to determine an optimal schedule for performing each step of the plurality of forward passes, the plurality of the gradient computation passes B and the plurality of parameters computation passes W.

According to one embodiment, activation memory of each step of the plurality of forward passes, the plurality of the gradient computation passes B and the plurality of parameters computation passes W is calculated.

According to one embodiment, the heuristic algorithm uses the calculated activation memory of each step of the plurality of forward passes, the plurality of the gradient computation passes B and the plurality of parameters computation passes W to determine the optimal schedule.

According to one embodiment, the calculated activation memory is used to schedule as many forward passes as possible before the gradient computation pass B to minimize the pipeline bubbles.

According to one embodiment, the neural network model is a feedforward neural network.

According to one embodiment, a computer readable storage medium, characterized in that the storage medium stores at least one program code for execution by a processor to implement the training method described above.

According to one embodiment, a computer program product, the computer program product comprising computer instructions stored in a computer readable storage medium; a processor of a computer device reads the computer instructions from the computer readable storage medium, the processor executing the computer instructions, causing the computer device to implement the training method described above.

It should be noted that embodiments described in context of the method of training a neural network model utilizing zero bubble pipeline parallelism are analogously valid for the system and vice versa.

### BRIEF DESCRIPTION OF THE DRAWINGS

The invention will be better understood with reference to the detailed description when considered in conjunction with the non-limiting examples and the accompanying drawings, in which:

FIG. 1 shows an exemplary method for training a neural network model utilizing zero bubble pipeline parallelism according to an embodiment.

FIG. 2 shows a computation graph for multilayer perceptron (MLP).

FIG. 3 shows an exemplary illustration of a 1F1B pipeline schedule according to an embodiment.

FIGS. 4A-4B show exemplary handcrafted pipeline schedules according to embodiments.

FIG. 5 shows exemplary post validation strategy according to an embodiment.

FIG. 6 shows charts comparing throughputs of different pipeline schedules according to embodiments.

FIGS. 7A and 7B show a pipeline schedule produced by ZB-2p and its profiled execution process exemplary post validation strategy according to an embodiment.

FIG. 8 shows relation between memory limit and bubble rate according to an embodiment.

FIGS. 9A and 9B show the schedule grouped by W and the schedule grouped by parameter according to embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the systems or methods are analogously valid for the other systems or methods. Similarly, embodiments described in the context of a system are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

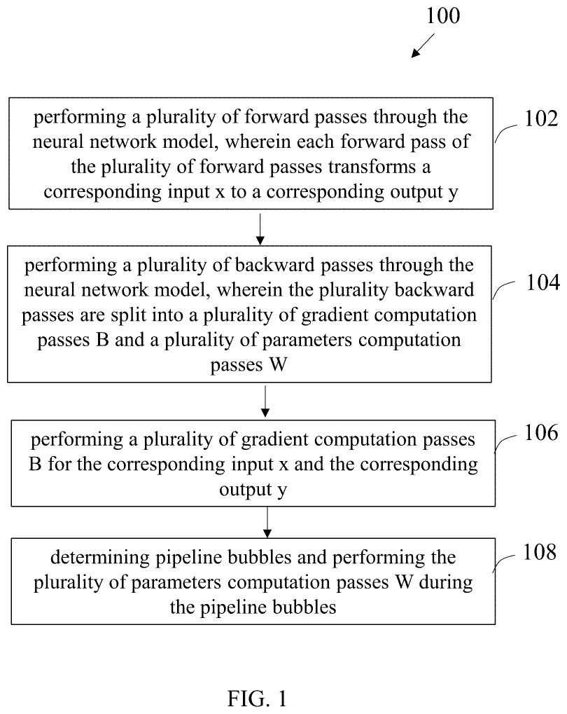

FIG. 1 shows an exemplary method for training a neural network model utilizing zero bubble pipeline parallelism according to an embodiment.

As shown in FIG. 1, there may be a method 100 of training a neural network model utilizing zero bubble pipeline parallelism. In the method 100, a first step 102 may include performing a plurality of forward passes through the neural network model, wherein each forward pass of the plurality of forward passes transforms a corresponding input x to a corresponding output y. A second step 104 may include performing a plurality of backward passes through the neural network model, wherein the plurality backward passes are split into a plurality of gradient computation passes B and a plurality of parameters computation passes W. A third step 106 may include performing a plurality of gradient computation passes B for the corresponding input x and the corresponding output y. A fourth step 108 may determining pipeline bubbles and performing the plurality of parameters computation passes W during the pipeline bubbles.

It will be understood that the above operations described above relating to FIG. 1 are not limited to this particular order. Any suitable, modified order of operations may be used.

According to one embodiment, each gradient computation pass B of the plurality of gradient computation passes B is performed after each forward pass of the plurality of forward passes for the corresponding input x and the corresponding output y.

According to one embodiment, each parameters computation pass W of the plurality of parameters computation passes W is performed after each gradient computation pass B of the plurality of gradient computation passes B for the corresponding input x and the corresponding output y.

According to one embodiment, the pipeline bubbles are idle times when the plurality of forward passes and the plurality of gradient computation passes B are not performed.

According to one embodiment, a heuristic algorithm is used to determine an optimal schedule for performing each step of the plurality of forward passes, the plurality of the gradient computation passes B and the plurality of parameters computation passes W.

According to one embodiment, activation memory of each step of the plurality of forward passes, the plurality of the gradient computation passes B and the plurality of parameters computation passes W is calculated.

According to one embodiment, the heuristic algorithm uses the calculated activation memory of each step of the plurality of forward passes, the plurality of the gradient computation passes B and the plurality of parameters computation passes W to determine the optimal schedule.

According to one embodiment, the calculated activation memory is used to schedule as many forward passes as possible before the gradient computation pass B to minimize the pipeline bubbles.

According to one embodiment, the neural network model is a feedforward neural network, such as a multilayer perceptron (MLP).

Detailed description of the method and system for training a neural network model utilizing zero bubble pipeline parallelism will be discussed below.

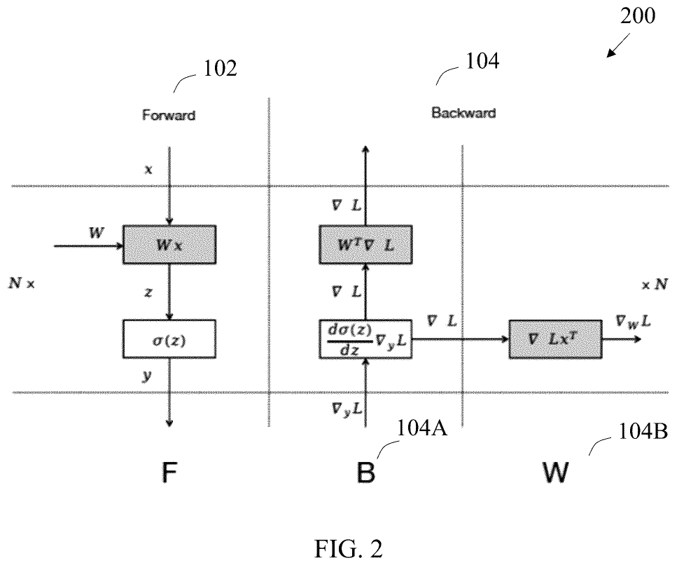

FIG. 2 shows a computation graph for multilayer perceptron (MLP).

A multilayer perceptron (MLP) is a type of feedforward artificial neural network.

According to various embodiments, neural networks are granularized as stacked layers. There are two functions associated with each layer, forward and backward. As shown in FIG. 2, the MLP 100 has forward passes 102 and backward passes 104.

According to various embodiments, in the forward pass F, input x is transformed into the output y with the parameterized mapping f(x, W). The backward pass, crucial for training, involves two computations:

$${∇}_{xf} {( x , W )}^{⊤} \frac{d ℓ}{dy} and {∇}_{wf} {( x , W )}^{⊤} \frac{d ℓ}{dy} .$$

Correspondingly, the two computations compute the gradient B with respect to the input x and the layer's parameters W. Traditionally, B and W are grouped and provided as a single backward function. This design is conceptually friendly to the user, and it happens to work well for DP, because the communication of the weights' gradient at layer i can be overlapped with the backward computation at layer i−1. However, in pipeline parallelism, this design unnecessarily increases the sequentially dependent computations, i.e. B at the layer i−1 depends on W at the layer i, which is usually detrimental for the efficiency of the pipeline as it creates pipeline bubbles

According to various embodiments, the backward pass 104 may be split into two parts, namely gradient computation pass B 104A and parameters computation pass W 104B. This will greatly improve pipeline efficiency by reducing sequential dependency, and reducing pipeline bubbles.

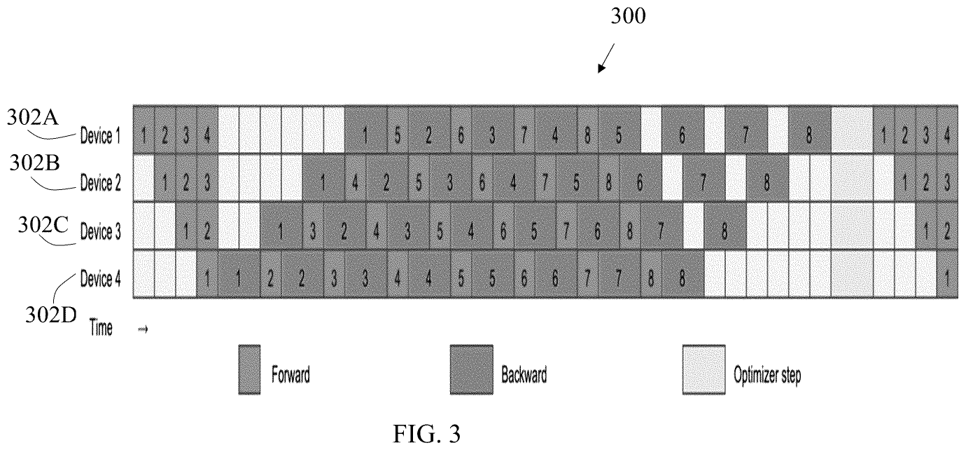

FIG. 3 shows an exemplary illustration of a 1F1B pipeline schedule according to an embodiment.

A 1F1B is a pipeline schedule with one forward pass followed by one backward pass.

As depicted in FIG. 3, 1F1B 300 initiates with a warm-up phase. In this phase, workers, which as also known as devices 302A-302D, conduct varying numbers of forward passes, with each stage typically performing one more forward pass than its immediately subsequent stage. Following the warm-up, each device 302A-302D transits to a steady state where they alternately execute one forward pass and one backward pass, ensuring an even workload distribution among stages. In the final phase, each device processes the backward passes for the outstanding in-flight microbatches, completing the batch.

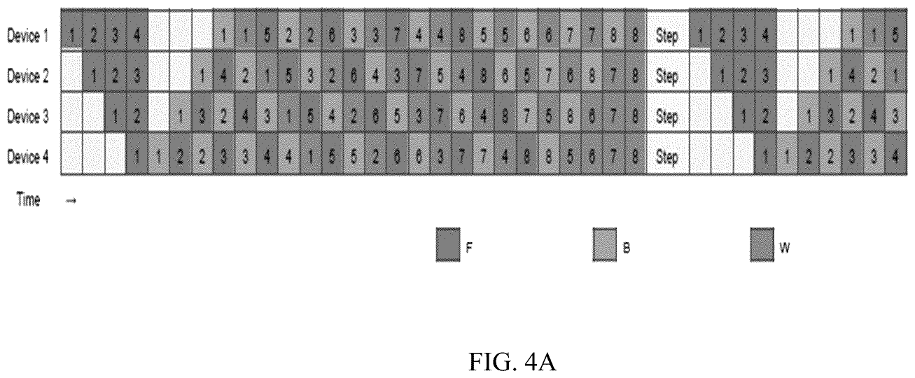

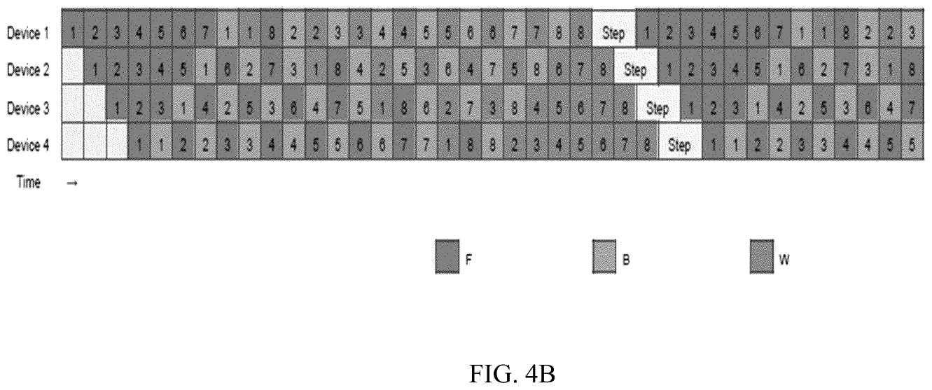

FIGS. 4A-4B show exemplary handcrafted pipeline schedules according to embodiments.

In the system disclosed herein, the backward pass is split into gradient pass B and parameter pass W.

The parameter pass W can be flexibly scheduled anywhere after the corresponding gradient pass B of the same stage. This allows for strategic placement of parameter pass W to fill the pipeline bubbles. There are many possible schedules that improve over 1F1B, trading off differently on the bubble size, the communication cost, and the memory footprint.

FIG. 4A shows a memory efficient schedule named ZB-H1. This memory efficient schedule ensures that the peak memory usage does not exceed that of 1F1B. ZB-H1 generally follows the 1F1B schedule, but adjusts the starting points of parameter pass W depending on the number of warm-up microbatches. This may ensure that all devices maintain the same number of in-flight microbatches. As a result, the pipeline bubble size is reduced to a third of 1F1B's size. This reduction is because gradient pass B is initiated earlier across all devices compared to 1F1B, and the tail-end bubble is filled by the later-starting parameter pass W. As parameter pass W typically uses less memory than gradient pass B (see Table 1), the first device has the peak memory usage which is consistent with 1F1B.

TABLE 1
FLOPs and activations memory required per transformer
layer for each pass

| Pass | FLOPs | Activations Memory Required |
|---|---|---|
| F | sbh(12 h +2 s) | 0 |
| B | sbh(12 h + 4 s) | sb(34 h + 5as) |
| W | sbh(12 h) | 32sbh |

FIG. 4B shows a zero bubble schedule named ZB-H2. When there is a larger memory footprint than 1F1B and there are sufficient number of microbatches, it is possible to achieve a zero bubble schedule, which is label as ZB-H2. This zero bubble schedule introduces more F passes during the warm-up phase to fill the bubble preceding the initial gradient pass B. The parameter pass W is reordered at the tail, which changes the layout from trapezoid into a parallelogram, eliminating all the bubbles in the pipeline. Also, the synchronization between the optimizer steps is removed here.

In various embodiments, p is used to denote the number of stages and b is used to denote the size of each microbatch. For the transformer architecture, the number of attention heads is denoted as a, the sequence length is denoted as s and the hidden dimension size is denoted as h. The notations MB/MW is used to represent the activation memory required for one B/W passes, TF/TB/TW is used to represent the running time for one F/B/W pass. For simplicity, only quantitative analyses is conducted on a transformer architecture, using a typical setting similar to GPT-3 where the hidden dimension size inside feedforward is 4 h and the dimension size for each attention head is h/a.

In various embodiments, only matrix multiplication (matmul) operations is considered when calculating floating point operations (FLOPs) because they contribute most of the computation in a transformer layer. For each matmul operation in the forward pass, there are two matmul operations with the same FLOPs in corresponding backward pass (see FIG. 1), each of which belongs to either B or W. The approximate formula for calculating the FLOPs of a transformer layer is in Table 1. It is shown that TW<TF<TB and TB+TW=2TF, and the activation memory required for B is estimated. After B completes, it releases some activations not used anymore but keeps some extra gradients (∇ₓL) for W. As shown in table 1 above, the total memory required by W is less than B.

Without the assumption of TF=TB=TW, the peak memory and bubble size of ZB-H1 and ZB-H2 are quantified in Table 2. Notably, the peak memory of worker i is

$$( ( p - i + 1 ) {M}_{B} + ( i - 1 ) {M}_{W} \leq {pM}_{B} and ( 2 p - 2 i + 1 ) {M}_{B} + ( 2 i - 2 ) {M}_{W} \leq ( 2 p - 1 ) {M}_{B}$$

for ZB-H1 and ZB-H2 respectively.

TABLE 2
Comparison between 1F1B and our handcrafted
schedules.

| Schedule | Bubble size | Peak memory |
|---|---|---|
| 1F1B | (p − 1)(T_{F} + T_{B} + T_{W}) | pM_{B} |
| ZB-H1 | (p − 1)(T_{F} + T_{B} + T_{W}) | pM_{B} |
| ZB-H2 | (p − 1)(T_{F} + T_{B} + 2T_{W}) | (2p − 1)M_{B} |

In various embodiments, while handcrafted schedules offer simplicity and better comprehensibility, such schedules face several issues in practical applications. For one, scheduling under the assumption that TF=TB=TW introduces unwanted bubbles, especially for models where these values differ significantly. Moreover, communication time (denoted as Tcomm) required to transfer activation/gradient between stages is often ignored in handcrafted schedules, leading to noticeable latency in the pipeline stream. Finally, striking a balance between minimizing bubble size and adhering to memory limit becomes particularly challenging when the available memory is insufficient to accommodate enough microbatches for a bubble-free schedule.

To address these challenges and ensure generalization to practical scenarios, heuristic algorithms to automatically search the optimal schedule given the number of pipeline stages p, the number of microbatches m, the memory limit Mlimit, and the running time estimations TF, TB, TW and Tcomm is disclosed. A heuristic strategy which always generates an optimal or near optimal solution especially when m is large enough is used. The problem is also systematically formulated as Integer Linear Programming (ILP), which can be solved by an off-the-shelf ILP solver, when the problem is under a certain scale. These two approaches can be combined: first, use the heuristic solution as initialization, and then fine-tune it with ILP.

In various embodiments, the heuristic algorithm may have the following steps:
In the warm-up phase, within the memory limit, schedule as many F passes as possible to minimize the bubble before the first B. The resulting schedule may still have a small bubble (less than TF) before the first B if not reaching memory limit, where a local search is done to make a deliberate decision because putting another F may delay the following B.
After the warm-up phase, the pattern is adhered where one F and one B are scheduled iteratively. W is inserted to fill the bubble when there is a gap larger than TW. When a bubble occurs but the size is less than TW, a W is still inserted if the current bubble makes the largest cumulative bubble size among all stages become larger. A W is also inserted to recycle some memory when the memory limit is hit. Typically, the heuristic strategy enters a steady state that follows 1F-1B-1W pattern.
Throughout this process, pipeline stage i is always guaranteed to schedule at least one more F than stage i+1 any time before F is used up. When this difference exceeds one, a local search is done to decide whether to skip one F in pipeline stage i if it does not cause more bubbles.
In each stage, when F and B passes run out, all the remaining W passes are scheduled one by one.

In various embodiments, for ILP formulation, any pass in the pipeline can be uniquely indexed by (i, j, c) where i∈{1, 2, . . . , p} indexes the stage, J∈{1, 2, . . . m} indexes the microbatch, and c∈{F, B, W} denotes the specific pass of the microbatch. The variable T_{(i,j,c)} may be defined as the time cost and E_{(i,j,c)} as the ending time of a pass. ΔM_{(i,j,c)} was used to denote the memory increment incurred by the pass (i, j, c). For example, ΔM_{(·,·,F)}=M_{B} because the forward pass leads to a net increase of M_{B} of activation stored for the backward pass. ΔM_{(·,·,B)}=M_{W}−M_{B} which removes the memory stored for B while adding those required by W, and ΔM_{(·,·,w})=−M_{W}. Finally, the variable to be searched is based on the ordering of the passes in the schedule, for which the variable O_{(i,j,c)→(i,j′,c′)}∈{0, 1} is introduced. This variable is an indicator whether the pass index by (i, j, c) is scheduled before (i, j′, c′).

$${min}_{O , E} {max}_{i} {E}_{( i , m , W )} - {E}_{( i , 1 , F )} + {T}_{( i , 1 , F )} \qquad ( 1 )$$

$$s . t . {E}_{( i , j , F )} \geq {E}_{( i - 1 , j , F )} + {T}_{comm} + {T}_{( i , j , F )} \qquad ( 2 )$$

$${E}_{( i , j , B )} \geq {E}_{( i + 1 , j , B )} + {T}_{comm} + {T}_{( i , j , B )} \qquad ( 3 )$$

$${E}_{( i , j , c )} \geq {E}_{( i , {j}^{′} , {c}^{′} )} + {T}_{( i , j , c )} - {O}_{( i , j , c ) \to ( i , {j}^{′} , {c}^{′} )} ∞ \qquad ( 4 )$$

$${M}_{limit} \geq Δ {M}_{( i , {j}^{′} , {c}^{′} )} + {\sum }_{j , c} Δ {M}_{( i , j , c )} {O}_{( i , j , c ) \to ( i , {j}^{′} , {c}^{′} )} \qquad ( 5 )$$

Overall, the optimization target (1) is to minimize the time spent by the longest stage. Constraints (2) and (3) add the sequential dependency requirements on the F and B passes of the same batch in adjacent stages. Additionally, (4) adds the dependency constraint imposed by our decision of the scheduling order. Finally, (5) limits the peak memory to be below Mₗᵢₘᵢₜ.

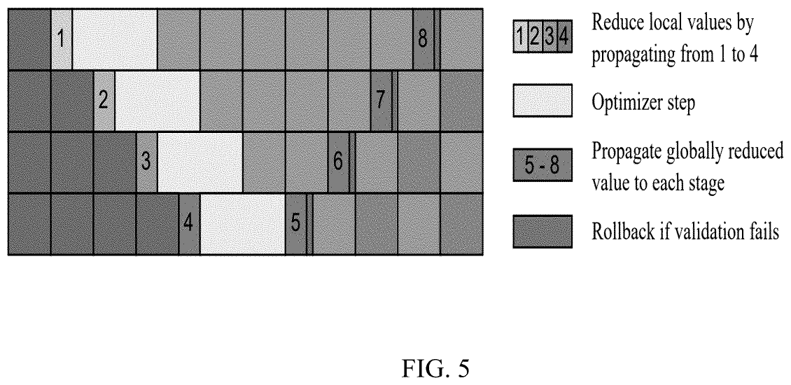

FIG. 5 shows exemplary post validation strategy according to an embodiment.

In most practices of pipeline parallelism, synchronizations over pipeline stages are usually performed in optimizer step for the sake of numerical robustness. For example, a global gradient norm needs to be computed for gradient norm clipping. A global check for NAN and INF values are performed in the mixed precision settings and both of them require an all-reduce communication across all stages. However, synchronization at the optimizer step destroys the parallelogram (FIG. 4) and makes zero bubble impossible. Therefore, an alternative mechanism to bypass these synchronizations, while still maintaining a synchronous optimization semantics is used.

In existing implementations, an all-reduce communication is first launched to collect the global states, followed by the optimizer steps which are conditioned on the global states. However, most of the time the global states have no effects, e.g., the global check for NAN and INF rarely trigger because in a robust setting most iterations should not have numerical issues. The gradient clipping rate is also quite low empirically to justify a synchronization of global gradient norm at every iteration.

Based on these observations, the before-hand synchronizations are replaced with a post update validation. The idea is illustrated in FIG. 5, at each stage before the optimizer step, a partially reduced global state is received from the previous stage, combined with the current stage's local state, and passed on to the next stage. The optimizer step of each stage is controlled by the partially reduced state, e.g. abort the update when a NAN is spotted. During the warm-up phase of the next iteration, the fully reduced global state is then propagated back from the last stage to first stage. Upon receiving the global state, each stage performs a validation to decide whether the previous optimizer step is legitimate. A rollback will be issued if an amendment to the gradient is required.

In an embodiment, the implementation is based on the open-source Megatron-LM project and its performance is assessed using models analogous to GPT-3 as detailed in Table 3.

In an embodiment, the model used may be a large language model such as GPT3. In an embodiment, any suitable model may be used.

During the experiments, a specific number of iterations for profiling, collecting empirical measurements for TF, TB, TW, and Tcomm is conducted. After obtaining these values, these values are fed into the automated pipeline scheduling algorithm to determine the optimal schedule. It is worth noting that both the initial and final pipeline stages possess one fewer transformer layer compared to the intermediate stages. This design is to compensate for the extra embedding lookup and loss computations in the initial and final stages so that they will not become the bottleneck and cause bubbles to other stages.

TABLE 3
Models and fixed settings used in experiments

| | | Attention | Hidden | Sequence | Pipelines | Microbatch | Number of |
|---|---|---|---|---|---|---|---|
| Model | Layers | Heads | Size | Length | (GPUs) | Size | Microbatches |
| 1.5B | 22 | 24 | 2304 | 1024 | 8 | 6 | 24/32/64 |
| 6.2B | 30 | 32 | 4096 | 1024 | 8 | 3 | 24/32/64 |
| 14.6B | 46 | 40 | 5120 | 1024 | 16 | 1 | 48/64/128 |
| 28.3B | 62 | 48 | 6144 | 1024 | 32 | 1 | 96/128/256 |

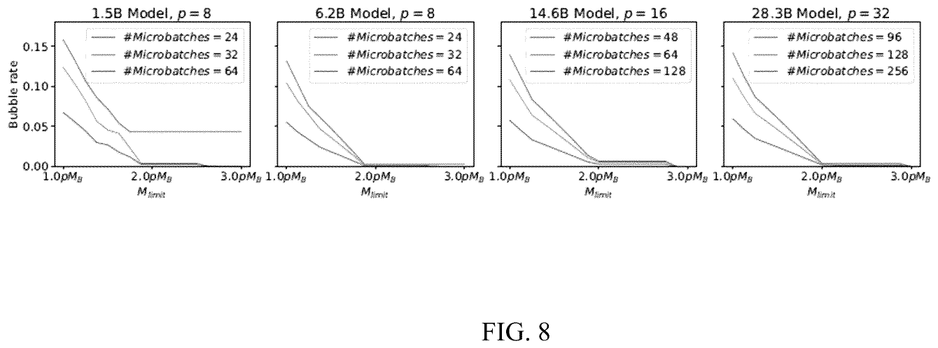

The following methods were compared:
ZB-1p: Automatically searched schedule with the activation memory limited to pM_{B}, which theoretically has the same peak memory as 1F1B.
ZB-2p: Automatically searched schedule with the activation memory limited to 2pM_{B}, which is the least amount of memory to empirically achieve close to zero bubble (see FIG. 8).
1F1B and 1F1B-I: 1F1B and interleaved 1F1B methods with implementation from Megatron-LM. For interleaved 1F1B, the entire model is divided into a sequence of chunks, which is cyclically taken by each stage, forming an interleaved pipeline. In the interleaved experiments, the maximum number of chunks is used to ensure least bubble, i.e. each transformer layer serves as a chunk.

The experiments utilize up to 32 NVIDIA A100 SXM 80G GPUs distributed across 4 nodes inter-connected by a RoCE RDMA network. The running time of each iteration is recorded after several warm-up iterations. Thanks to the reproducibility provided by Megatron-LM implementation, the correctness of ZB-1 p and ZB-2p without running models can be verified until convergence. A fixed random seed is used to initialize the model and record the loss after every iteration for ZB-1p, ZB-2p, and 1F1B and then verified that they are bit-to-bit identical.

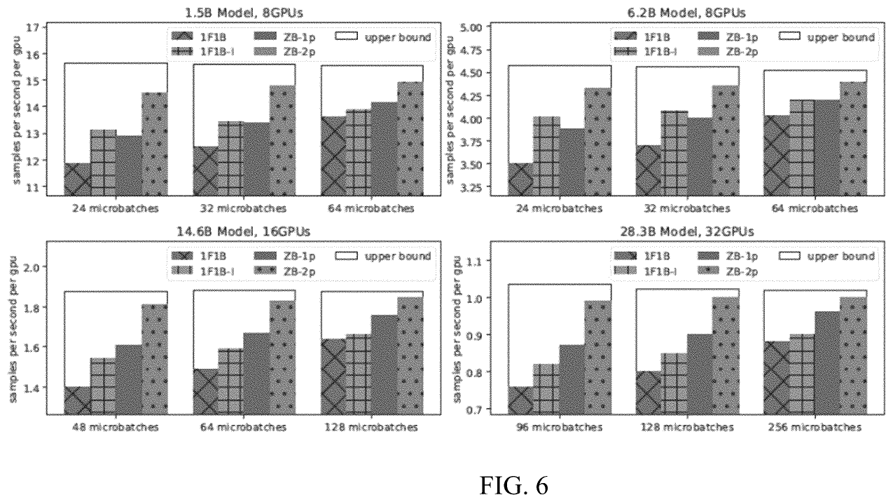

FIG. 6 shows charts comparing throughputs of different pipeline schedules according to embodiments.

Table 4 shows the experiment results. The experiments demonstrate that ZB-2p consistently outperforms all other methods across various settings. Notably, the throughput of 1F1B, 1F1B-I and ZB-1p show a strong positive correlation with the number of microbatches. In contrast, ZB-2p maintains the efficiency even with fewer microbatches. This is because the bubble rate in ZB-2p has almost reached zero (Table 5), and its throughput is already close to the upper bound. Here the upper bound is roughly estimated by multiplying the throughput of 1F1B and

$$\frac{1}{1 - bubble rate of 1 F 1 B} .$$

As mentioned before, the improved efficiency of ZB-2p comes at the cost of a higher memory consumption (2pM_{B}) compared to the 1F1B baseline (pM_{B}). In contrast, ZB-1p is designed to have a peak memory cost similar to the baselines. It shows a comparable throughput to 1F1B interleave in the 8 GPU setups. In multi-node setups where communication bandwidth is more of a bottleneck, ZB-1p clearly outperforms 1F1B-I, highlighting its advantage in reducing pipeline bubbles without incurring extra communication cost.

TABLE 4
Experiment result details

| | | Model | | | | | | | | | | | |
|---|---|---|---|---|---|---|---|---|---|---|---|---|---|
| | | 1.5B | | | 6.2B | | | 14.6B | | | 28.3B | | |
| | | #GPU | | | | | | | | | | | |
| | | 8 | | | 8 | | | 16 | | | 32 | | |
| | | #Microbatch | | | | | | | | | | | |
| Setup | | 24 | 32 | 64 | 24 | 32 | 64 | 48 | 64 | 128 | 96 | 128 | 256 |
| Samples | ZB-2p | 14.5 | 14.8 | 14.9 | 4.32 | 4.35 | 4.39 | 1.81 | 1.83 | 1.85 | 0.99 | 1.00 | 1.00 |
| per GPU | ZB-1p | 12.9 | 13.4 | 14.2 | 3.88 | 4.00 | 4.20 | 1.61 | 1.67 | 1.76 | 0.87 | 0.90 | 0.96 |
| per second | 1F1B | 11.8 | 12.5 | 13.6 | 3.50 | 3.70 | 4.03 | 1.40 | 1.49 | 1.64 | 0.76 | 0.80 | 0.88 |
| | 1F1B-I | 13.1 | 13.4 | 13.9 | 4.01 | 4.08 | 4.19 | 1.54 | 1.59 | 1.66 | 0.82 | 0.85 | 0.90 |
| Memory | ZB-2p | 59 | 59 | 59 | 70 | 70 | 70 | 51 | 51 | 51 | 74 | 74 | 74 |
| (GB) | ZB-1p | 32 | 32 | 32 | 42 | 42 | 42 | 33 | 33 | 33 | 44 | 44 | 44 |
| | 1F1B | 30 | 30 | 30 | 39 | 39 | 39 | 32 | 32 | 32 | 43 | 43 | 43 |
| | 1F1B-I | 40 | 40 | 40 | 48 | 48 | 48 | 39 | 39 | 39 | 58 | 58 | 58 |

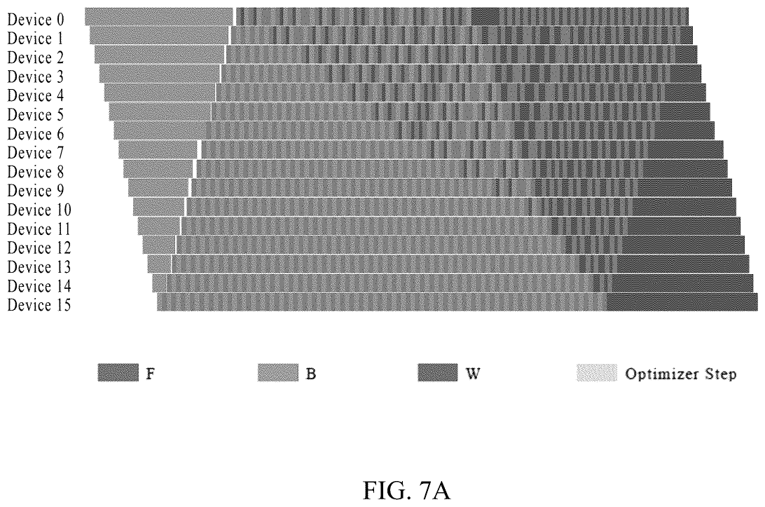

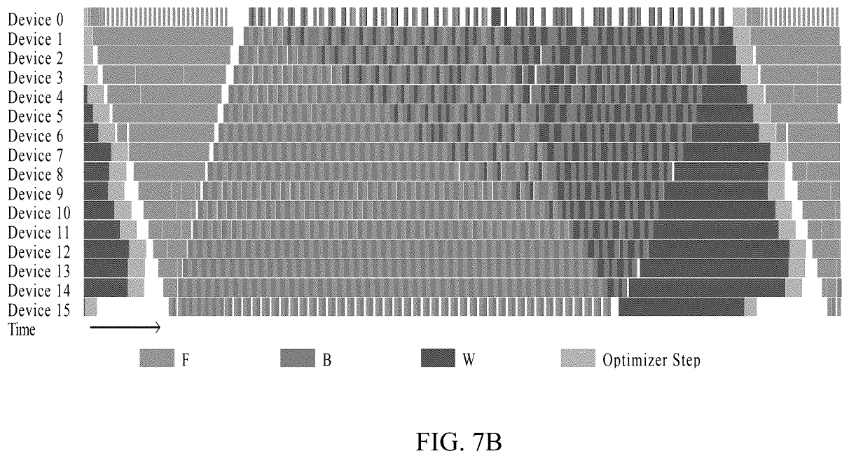

FIGS. 7A and 7B show a pipeline schedule produced by ZB-2p and its profiled execution process exemplary post validation strategy according to an embodiment.

To quantify the efficiency of a pipeline schedule, bubble rate which is calculated as (cost−m(TF+TB+TW))/cost is used. The cost here is defined as the largest execution time of all stages, calculated for each schedule using profiled TF, TB, TW and Tcomm values. The m(TF+TB+TW) is the optimal execution time when all communications are overlapped with computation and hence no bubbles in the pipeline.

The bubble rates for different schedules are presented in Table 5. The handcrafted schedules ZB-H1 and ZB-H2 are included as baselines to the automatically searched schedules. In most of the settings, ZB-2p produces a bubble rate of less than 1%, which is the best among all schedules. In contrast, ZB-H2 consistently performs worse than ZB-2p. This provides a strong evidence that the automatic scheduling algorithm adapts better to realistic scenarios by using more accurate estimates of TF, TB, TW and Tcomm. On the contrary, this improvement is not observed in ZB-1p vs ZB-H1, hypothetically because the memory limit becomes the dominate factor. Notably, all of the methods disclosed significantly outperform 1F1B.

ZB-2p and its profiled real execution is also plotted on 16 GPUs to provide a direct visual evidence that it is a zero bubble schedule. As shown in FIGS. 7A and 7B, the automatically generated ZB-2p schedule has almost no bubble. The profiled execution has slightly more bubbles but retains a good overall alignment.

TABLE 5
Bubble rates of 1F1B, 1F1B-I, ZB-H1, ZB-H2, ZB-1p, ZB-2p under different settings.

| Model | #Stage (p) | #Microbatch (m) | 1F1B | 1F1B-I | ZB-H1 | ZB-H2 | ZB-1p | ZB-2p |
|---|---|---|---|---|---|---|---|---|
| 1.5B | 8 | 24 | 0.2431 | 0.1055 | 0.1585 | 0.1083 | 0.1585 | 0.0433 |
| | | 32 | 0.1985 | 0.0818 | 0.1242 | 0.0837 | 0.1242 | 0.0039 |
| | | 64 | 0.1240 | 0.0443 | 0.0674 | 0.0444 | 0.0674 | 0.0026 |
| 6.2B | 8 | 24 | 0.2347 | 0.0808 | 0.1323 | 0.0698 | 0.1323 | 0.0029 |
| | | 32 | 0.1898 | 0.0628 | 0.1045 | 0.0559 | 0.1045 | 0.0022 |
| | | 64 | 0.1091 | 0.0320 | 0.0554 | 0.0294 | 0.0554 | 0.0010 |
| 14.6B | 16 | 48 | 0.2552 | 0.1104 | 0.1397 | 0.0672 | 0.1397 | 0.0066 |
| | | 64 | 0.2082 | 0.0852 | 0.1088 | 0.0516 | 0.1088 | 0.0054 |
| | | 128 | 0.1251 | 0.0445 | 0.0576 | 0.0266 | 0.0576 | 0.0028 |
| 28.3B | 32 | 96 | 0.2646 | 0.1493 | 0.1421 | 0.0641 | 0.1421 | 0.0038 |
| | | 128 | 0.2168 | 0.1164 | 0.1106 | 0.0490 | 0.1106 | 0.0029 |
| | | 256 | 0.1352 | 0.0624 | 0.0594 | 0.0257 | 0.0594 | 0.0018 |

FIG. 8 shows relation between memory limit and bubble rate according to an embodiment.

To better understand the effect of the peak memory limit, the relationship of the bubble rate to the memory limit is conducted. The automatic scheduling algorithm with a series of memory limits is conducted and plotted them. Initially, the bubble rate shows a close-to-linear decreasing trend as the memory limit increases. Theoretically, the curve should plateau around

$$\frac{{pT}_{F} + ( p - 1 ) {T}_{B} + 2 ( p - 1 ) {T}_{comm}}{{T}_{F}} {M}_{B} .$$

Empirically, 2pM_{B} is a good threshold for achieving close to zero bubble rate when TF≈TB and Tcomm is relatively small. Beyond the inflection point, although a sufficiently large memory limit does result in a theoretically zero bubble rate, in general the cost outweighs the gain.

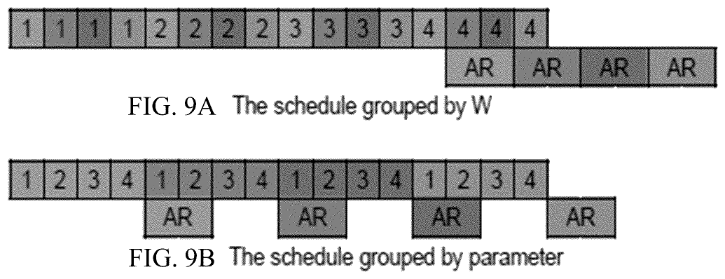

FIGS. 9A and 9B show the schedule grouped by W and the schedule grouped by parameter according to embodiments.

When data parallelism is taken into consideration, an all-reduce communication will be launched to collect gradients before optimizer step. Generally, such communication is poorly overlapped with computation pass, resulting in a latency especially when the communication bandwidth is limited.

As shown in FIGS. 4A and 4B, usually a number of W are scheduled at the tail of an iteration. For each W pass, it includes several independent computations calculating gradients for different parameters. As in shown in FIGS. 9A and 9B, all of these computations can be reordered to cluster those calculating the gradient of the same parameter, thus achieving the optimal overlapping between computation and communication.

According to various embodiments, the relation between memory limit and bubble rate is highly affected by the bubbles preceding the first B in the initial stage. For the first microbatch, the forward pass needs to go through from the initial stage to final stage, and the backward pass reverses this process until it eventually goes back to the initial stage. The total time for the first microbatch from start to completion takes at least p(T_{F}+T_{B})+2(p−1)T_{comm} and it cannot be squeezed due to the dependency chains. The number of F passes is denoted as k≥1 and the bubble size as β≥0, preceding the first B pass in the initial stage. Then:

$${M}_{limit} \geq {kM}_{B} \qquad ( 6 )$$

$$β = p ( {T}_{F} + {T}_{B} ) + 2 ( p - 1 ) {T}_{comm} - {kT}_{F} - {T}_{B} = ( p - 1 ) ( {T}_{B} + 2 {T}_{comm} ) + ( p - k ) {T}_{F} \qquad ( 7 )$$

When increasing k and keeping

$$k \leq ⌊ \frac{( p - 1 ) ( {T}_{B} + 2 {T}_{comm} ) + {pT}_{F}}{{T}_{F}} ⌋ ,$$

the size of considered bubble β decreases linearly.

If the number of microbatches is only 1, it incurs a pipeline bubble with size (p−1) (TF+TB+2Tcomm). To fill this bubble, a number of extra F passes need to be scheduled preceding the B pass of the first microbatch. When this number is increases until it reaches

$$⌊ \frac{( p - 1 ) ( {T}_{F} + {T}_{B} + 2 {T}_{comm} )}{{T}_{F}} ⌋ ,$$

the size of considered bubble should decrease linearly.

In the experiments, the profiled time of TF, TB, TW, and Tcomm in ZB-2p across different settings are recorded. These values are then used to calculate bubble rates for all the methods considered above. These values can be found in Table 6.

TABLE 6
Profiled time of T_{F}, T_{B}, T_{W}, and T_{comm}.

| | #Stage | #Microbatch | | | | |
|---|---|---|---|---|---|---|
| Model | (p) | (m) | T_{F} | T_{B} | T_{W} | T_{comm} |
| 1.5B | 8 | 24 | 18.522 | 18.086 | 9.337 | 0.601 |
| | | 32 | 18.513 | 18.086 | 9.331 | 0.626 |
| | | 64 | 18.546 | 18.097 | 9.321 | 0.762 |
| 6.2B | 8 | 24 | 29.718 | 29.444 | 19.927 | 0.527 |
| | | 32 | 29.802 | 29.428 | 19.530 | 0.577 |
| | | 64 | 29.935 | 29.621 | 19.388 | 0.535 |
| 14.6B | 16 | 48 | 11.347 | 11.248 | 8.132 | 0.377 |
| | | 64 | 11.307 | 11.254 | 8.101 | 0.379 |
| | | 128 | 11.325 | 11.308 | 8.109 | 0.378 |
| 28.3B | 32 | 96 | 10.419 | 10.207 | 7.715 | 0.408 |
| | | 128 | 10.408 | 10.204 | 7.703 | 0.408 |
| | | 256 | 10.402 | 10.248 | 7.698 | 0.460 |

Aspects of the disclosed invention can include one or more of the following, including variations thereof:

Aspect 1. A computer-implemented method for training a neural network model utilizing zero bubble pipeline parallelism, the computer-implemented method comprising: performing a plurality of forward passes through the neural network model, wherein each forward pass of the plurality of forward passes transforms a corresponding input x to a corresponding output y; performing a plurality of backward passes through the neural network model, wherein the plurality backward passes are split into a plurality of gradient computation passes B and a plurality of parameters computation passes W; performing a plurality of gradient computation passes B for the corresponding input x and the corresponding output y; and determining pipeline bubbles and performing the plurality of parameters computation passes W during the pipeline bubbles.

Aspect 2. The computer implemented method of Aspect 1, wherein each gradient computation pass B of the plurality of gradient computation passes B is performed after each forward pass of the plurality of forward passes for the corresponding input x and the corresponding output y.

Aspect 3. The computer implemented method of any of Aspects 1 to 2, wherein each parameters computation pass W of the plurality of parameters computation passes W is performed after each gradient computation pass B of the plurality of gradient computation passes B for the corresponding input x and the corresponding output y.

Aspect 4. The computer implemented method of any of Aspects 1 to 3, wherein the pipeline bubbles are idle times when the plurality of forward passes and the plurality of gradient computation passes B are not performed.

Aspect 5. The computer implemented method of any of Aspects 1 to 4, wherein a heuristic algorithm is used to determine an optimal schedule for performing each step of the plurality of forward passes, the plurality of the gradient computation passes B and the plurality of parameters computation passes W.

Aspect 6. The computer implemented method of any of Aspects 1 to 5, wherein activation memory of each step of the plurality of forward passes, the plurality of the gradient computation passes B and the plurality of parameters computation passes W is calculated.

Aspect 7. The computer implemented method of any of Aspects 1 to 6, wherein the heuristic algorithm uses a calculated activation memory for each step of the plurality of forward passes, the plurality of the gradient computation passes B and the plurality of parameters computation passes W to determine the optimal schedule.

Aspect 8. The computer implemented method of any of Aspects 1 to 7, wherein the calculated activation memory is used to schedule as many forward passes as possible before the gradient computation passes B to minimize the pipeline bubbles.

Aspect 9. The computer implemented method of any of Aspects 1 to 8, wherein the neural network model is a feedforward neural network.

Aspect 10. A system for training a neural network model utilizing zero bubble pipeline parallelism comprising: a processor, a memory, the memory storing at least one program code, the at least one program code loaded and executed by the processor to: perform a plurality of forward passes through the neural network model, wherein each forward pass of the plurality of forward passes transforms a corresponding input x to a corresponding output y; perform a plurality of backward passes through the neural network model, wherein the plurality backward passes are split into a plurality of gradient computation passes B and a plurality of parameters computation passes W; perform a plurality of gradient computation passes B for the corresponding input x and the corresponding output y; and determine pipeline bubbles and performing the plurality of parameters computation passes W during the pipeline bubbles.

Aspect 11. The system of Aspect 10, wherein each gradient computation pass B of the plurality of gradient computation passes B is performed after each forward pass of the plurality of forward passes for the corresponding input x and the corresponding output y.

Aspect 12. The system of any of Aspects 10 to 11, wherein each parameters computation pass W of the plurality of parameters computation passes W is performed after each gradient computation pass B of the plurality of gradient computation passes B for the corresponding input x and the corresponding output y.

Aspect 13. The system of any of Aspects 10 to 12, wherein the pipeline bubbles are idle times when the plurality of forward passes and the plurality of gradient computation passes B are not performed.

Aspect 14. The system of any of Aspects 10 to 13, wherein a heuristic algorithm is used to determine an optimal schedule for performing each step of the plurality of forward passes, the plurality of the gradient computation passes B and the plurality of parameters computation passes W.

Aspect 15. The system of any of Aspects 10 to 14, wherein activation memory of each step of the plurality of forward passes, the plurality of the gradient computation passes B and the plurality of parameters computation passes W is calculated.

Aspect 16. The system of any of Aspects 10 to 15, wherein the heuristic algorithm uses the calculated activation memory of each step of the plurality of forward passes, the plurality of the gradient computation passes B and the plurality of parameters computation passes W to determine the optimal schedule.

Aspect 17. The system of any of Aspects 10 to 16, wherein the calculated activation memory is used to schedule as many forward passes as possible before the gradient computation pass B to minimize the pipeline bubbles.

Aspect 18. The system of any of Aspects 10 to 17, wherein the neural network model is a feedforward neural network.

Aspect 19. A computer readable storage medium, characterized in that the storage medium stores at least one program code for execution by a processor to implement operations for: performing a plurality of forward passes through a neural network model, wherein each forward pass of the plurality of forward passes transforms a corresponding input x to a corresponding output y; performing a plurality of backward passes through the neural network model, wherein the plurality backward passes are split into a plurality of gradient computation passes B and a plurality of parameters computation passes W; performing a plurality of gradient computation passes B for the corresponding input x and the corresponding output y; and determining pipeline bubbles and performing the plurality of parameters computation passes W during the pipeline bubbles.

Aspect 20. A computer program product, the computer program product comprising computer instructions stored in a computer readable storage medium; a processor of a computer device reads the computer instructions from the computer readable storage medium, the processor executing the computer instructions, causing the computer device to perform operations for: performing a plurality of forward passes through a neural network model, wherein each forward pass of the plurality of forward passes transforms a corresponding input x to a corresponding output y; performing a plurality of backward passes through the neural network model, wherein the plurality backward passes are split into a plurality of gradient computation passes B and a plurality of parameters computation passes W; performing a plurality of gradient computation passes B for the corresponding input x and the corresponding output y; and determining pipeline bubbles and performing the plurality of parameters computation passes W during the pipeline bubbles.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A computer-implemented method for training a neural network model utilizing zero bubble pipeline parallelism, the computer-implemented method comprising:
performing a plurality of forward passes through the neural network model, wherein each forward pass of the plurality of forward passes transforms a corresponding input x to a corresponding output y;
performing a plurality of backward passes through the neural network model, wherein the plurality backward passes are split into a plurality of gradient computation passes B and a plurality of parameters computation passes W;
performing a plurality of gradient computation passes B for the corresponding input x and the corresponding output y; and
determining pipeline bubbles and performing the plurality of parameters computation passes W during the pipeline bubbles.

2. The computer implemented method of claim 1, wherein each gradient computation pass B of the plurality of gradient computation passes B is performed after each forward pass of the plurality of forward passes for the corresponding input x and the corresponding output y.

3. The computer implemented method of claim 1, wherein each parameters computation pass W of the plurality of parameters computation passes W is performed after each gradient computation pass B of the plurality of gradient computation passes B for the corresponding input x and the corresponding output y.

4. The computer implemented method of claim 1, wherein the pipeline bubbles are idle times when the plurality of forward passes and the plurality of gradient computation passes B are not performed.

5. The computer implemented method of claim 1, wherein a heuristic algorithm is used to determine an optimal schedule for performing each step of the plurality of forward passes, the plurality of the gradient computation passes B and the plurality of parameters computation passes W.

6. The computer implemented method of claim 5, wherein activation memory of each step of the plurality of forward passes, the plurality of the gradient computation passes B and the plurality of parameters computation passes W is calculated.

7. The computer implemented method of claim 6, wherein the heuristic algorithm uses a calculated activation memory for each step of the plurality of forward passes, the plurality of the gradient computation passes B and the plurality of parameters computation passes W to determine the optimal schedule.

8. The computer implemented method of claim 7, wherein the calculated activation memory is used to schedule as many forward passes as possible before the gradient computation passes B to minimize the pipeline bubbles.

9. The computer implemented method of claim 1, wherein the neural network model is a feedforward neural network.

10. A system for training a neural network model utilizing zero bubble pipeline parallelism comprising:
a processor, a memory, the memory storing at least one program code, the at least one program code loaded and executed by the processor to:
perform a plurality of forward passes through the neural network model, wherein each forward pass of the plurality of forward passes transforms a corresponding input x to a corresponding output y;
perform a plurality of backward passes through the neural network model, wherein the plurality backward passes are split into a plurality of gradient computation passes B and a plurality of parameters computation passes W;
perform a plurality of gradient computation passes B for the corresponding input x and the corresponding output y; and
determine pipeline bubbles and performing the plurality of parameters computation passes W during the pipeline bubbles.

11. The system of claim 10, wherein each gradient computation pass B of the plurality of gradient computation passes B is performed after each forward pass of the plurality of forward passes for the corresponding input x and the corresponding output y.

12. The system of claim 10, wherein each parameters computation pass W of the plurality of parameters computation passes W is performed after each gradient computation pass B of the plurality of gradient computation passes B for the corresponding input x and the corresponding output y.

13. The system of claim 10, wherein the pipeline bubbles are idle times when the plurality of forward passes and the plurality of gradient computation passes B are not performed.

14. The system of claim 10, wherein a heuristic algorithm is used to determine an optimal schedule for performing each step of the plurality of forward passes, the plurality of the gradient computation passes B and the plurality of parameters computation passes W.

15. The system of claim 14, wherein activation memory of each step of the plurality of forward passes, the plurality of the gradient computation passes B and the plurality of parameters computation passes W is calculated.

16. The system of claim 15, wherein the heuristic algorithm uses the calculated activation memory of each step of the plurality of forward passes, the plurality of the gradient computation passes B and the plurality of parameters computation passes W to determine the optimal schedule.

17. The system of claim 16, wherein the calculated activation memory is used to schedule as many forward passes as possible before the gradient computation pass B to minimize the pipeline bubbles.

18. The system of claim 10, wherein the neural network model is a feedforward neural network.

19. A computer readable storage medium, characterized in that the storage medium stores at least one program code for execution by a processor to implement operations for:
performing a plurality of forward passes through a neural network model, wherein each forward pass of the plurality of forward passes transforms a corresponding input x to a corresponding output y;
performing a plurality of backward passes through the neural network model, wherein the plurality backward passes are split into a plurality of gradient computation passes B and a plurality of parameters computation passes W;
performing a plurality of gradient computation passes B for the corresponding input x and the corresponding output y; and
determining pipeline bubbles and performing the plurality of parameters computation passes W during the pipeline bubbles.

20. The computer readable storage medium of claim 19, wherein each gradient computation pass B of the plurality of gradient computation passes B is performed after each forward pass of the plurality of forward passes for the corresponding input x and the corresponding output y.
